(19) United States
(12) Patent Application Publication
(10) Pub. No.: US 2006/0164588 A1
(43) Pub. Date: Jul. 27, 2006

(54) Liquid crystal display panel

(75) Inventors: Hao-Yu Chang, Jhubei City (TW); Jung-Hsiang Lin, Taichung City (TW); Jen-Lang Tung, Kaohsiung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/141,305

(22) Filed: May 31, 2005

(30) Foreign Application Priority Data
Jan. 27, 2005 (TW) 94102442

(51) Int. Cl. G02F 1/1339

(52) U.S. Cl. 349/155

(57) ABSTRACT

A liquid crystal display panel is provided. The liquid crystal display panel includes a first substrate, a second substrate disposed parallel to the first substrate, a liquid crystal layer interposed therebetween, and a plurality of hybrid spacers disposed between the first substrate and second substrate, wherein the hybrid spacers comprise a soft material and a rigid material.

### BACKGROUND

The invention relates to a liquid crystal display panel and in particular to a liquid crystal display panel having a specific spacer and fabrication method thereof.

Liquid crystal display panels are among the most popular type of displays. FIG. 1 is a cross section of a liquid crystal display panel. The liquid crystal display panel comprises a first substrate 12 and a second substrate 14. The first substrate 12 and the second substrate 14 may be glass substrate, color filter (CF) substrate or thin film transistor (TFT) substrate. A plurality of spacers 18 are disposed between the first substrate 12 and the second substrate 14 for filling liquid crystal 16 therebetween.

One drop fill (ODF) shown in FIG. 2A˜2C is one of the most important technologies for liquid crystal display panel fabrications. In FIG. 2A, gel 13 is coated on the first substrate 12. Liquid crystal 16 is dropped on the first substrate 12, and then second substrate 14 is assembled with first substrate 12 in vacuum as shown in FIG. 2B. After back to atmosphere pressure, the two substrates 12 and 14 are assembled to form a liquid crystal display panel, as shown in FIG. 2C. Spacers 18 as shown in FIG. 1 can be disposed on first substrate 12 or second substrate 14. The amount of the liquid crystal 16 is based on the volume of spacer 18.

However, bubbles form as the liquid crystal or the spacers shift. Bubbles formation deteriorates the performance of the liquid crystal display panel.

One way to address the bubble problem is to use softer spacers to improve the liquid crystal margin (LC margin), but the compressive resistance of the liquid crystal display panel decreases.

### SUMMARY

Accordingly, embodiments of the invention provide a liquid crystal display panel and a fabrication method thereof.

In an embodiment of the invention, a liquid crystal display panel comprises a first substrate, a second substrate disposed parallel to the first substrate, a liquid crystal layer interposed between the first substrate and the second substrate and a plurality of hybrid spacers disposed between the first substrate and second substrate, wherein the hybrid spacers comprise a soft material and a rigid material.

In another embodiment, a fabrication method for a liquid crystal display panel is provided. This method comprises providing a first substrate and forming a plurality of hybrid spacers on the first substrate. The hybrid spacers comprise a soft material and a rigid material. Liquid crystal is applied to the first substrate. A second substrate is assembled with the first substrate.

### DESCRIPTION OF THE DRAWINGS

The embodiments can be more fully understood by reading the subsequent detailed description and examples with references made to the accompanying drawings, wherein:

FIG. 1 is a cross section illustrating a conventional liquid crystal display panel structure.

FIGS. 2A to 2C are cross sections illustrating a fabrication process of a conventional liquid crystal display panel.

FIGS. 3A to 3C are cross sections illustrating a fabrication process of a liquid crystal display panel of an embodiment.

FIGS. 4A to 4C are cross sections illustrating hybrid spacer structures of embodiments of the invention.

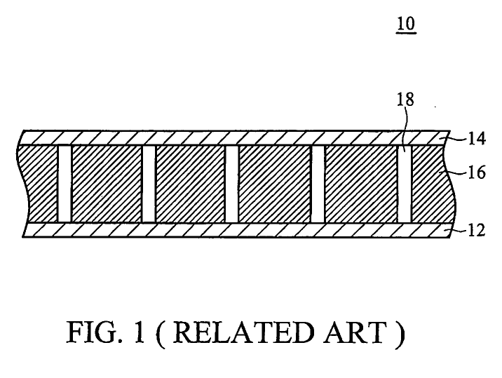

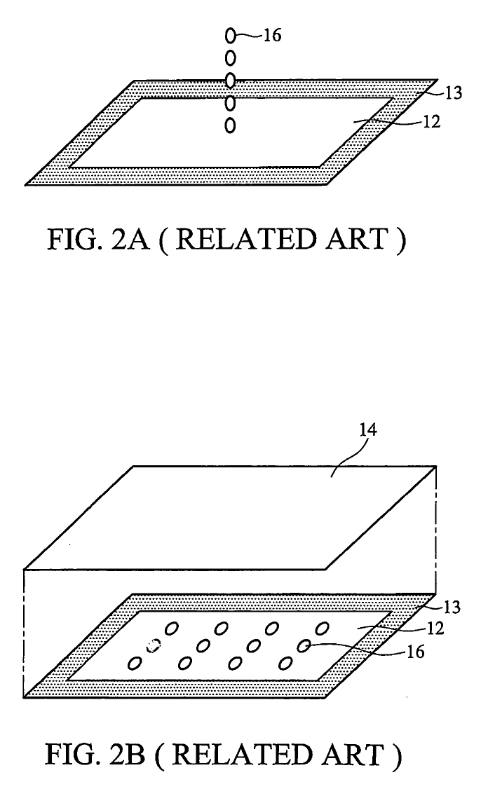

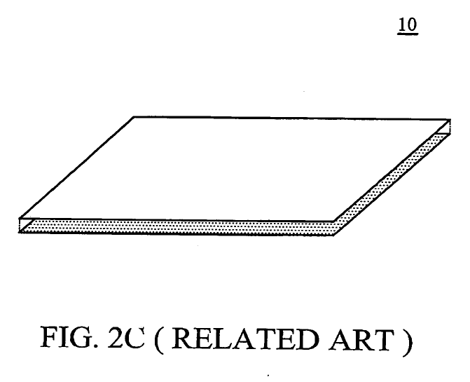

### DETAILED DESCRIPTION

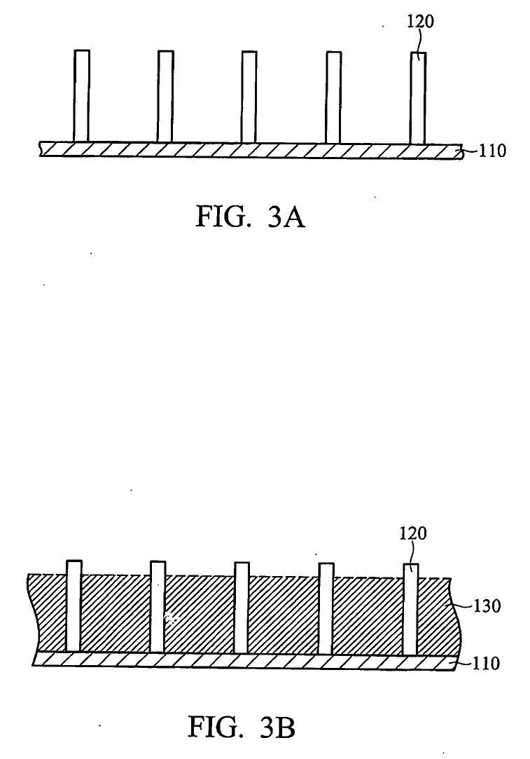

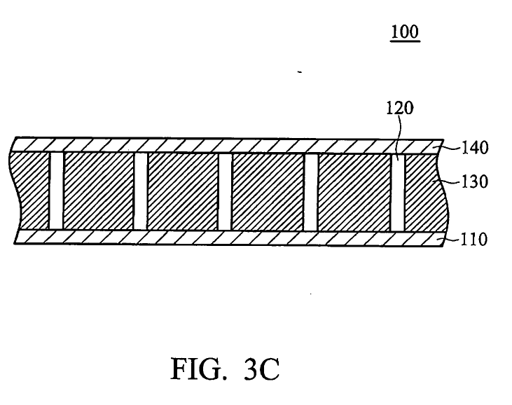

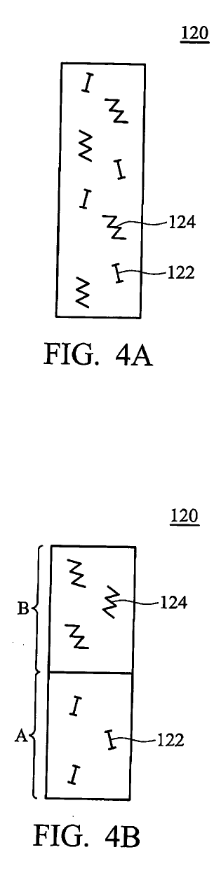

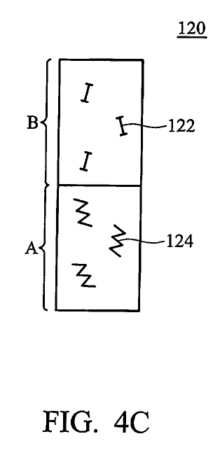

Embodiments of liquid crystal display panels are described with FIG. 3A to 3C and FIG. 4A to 4C.

In FIG. 3A, a plurality of hybrid spacers 120 are formed on first substrate 110. The first substrate 110 may be thin film transistor (TFT) substrate or color filter (CF) substrate, comprising a glass or indium tin oxide (ITO) substrate. The hybrid spacers 120 may be formed by photoresist or acrylic resin. The hybrid spacers 120 comprise a soft material 124 and a rigid material 122. The soft material 124 has pencil hardness of less than about 3H, and the rigid material 122 has pencil hardness more of than about 3H. The soft material 124 and the rigid material 122 are distributed uniformly contained in hybrid spacer 120 as shown in FIG. 4A, or are layered distributed as shown in FIGS. 4B and 4C. The ratio of soft material 124 and the rigid material 122 can be altered depending on different needs. Note that the terms “soft” and “rigid” merely represent relative hardness, not necessarily limited to pencil hardness. Furthermore, those skilled in the art will understand that more than two materials of different hardness may be used to form the hybrid spacer of the invention.

A method for forming hybrid spacers 120 as shown in FIG. 4A is described in the following. A hybrid spacer 120 including soft material 124 and rigid material 122 is coated on the first substrate 110. The hybrid mixture of hybrid spacer 120 can be prepared by mixing the soft material 124 and the rigid material 122 or by using a hybrid photoresist comprising soft material 124 and rigid material 122. The hybrid layer may be patterned by lithography and etching to form a plurality of hybrid spacers 120.

A method for forming hybrid spacers 120 as shown in FIGS. 4B and 4C is described in the following. A hybrid mixture including soft material 124 and rigid material 122 is coated on the first substrate 110 to form a hybrid layer. The characteristics of soft material 124 and rigid material 122, such as density difference, hydrophilic, hydrophobic, surface tension, soft material 124 and rigid material 122 in the hybrid mixture enable natural layer distribution. After patterning the hybrid layer, the hybrid spacer 120 is formed shown as FIG. 4B or FIG. 4C.

Another method for forming hybrid spacers 120 as shown in FIGS. 4B and 4C is described in the following. A first layer A and a second layer B are formed on the first substrate 110 sequentially. After patterning the first layer A and the second layer B, the hybrid spacer 120 is formed shown as FIG. 4B or FIG. 4C. The hybrid spacer 120 comprising the first layer A including the rigid material 122 and the second layer B including the soft material 124 is shown as FIG. 4B. The hybrid spacer 120 comprising the first layer A including the soft material 124 and the second layer B including the rigid material 122 is shown as FIG. 4C.

The thickness of hybrid spacer 120 depends on the predetermined space between the first substrate 110 and the subsequent assembles of second substrate 140. The thickness of the hybrid spacer 120 is about 1 to 10 μm. The hybrid spacer 120 is pillar-shaped or ball-shaped.

In FIG. 3B, liquid crystal is dropped onto the first substrate 110 by the one drop fill (ODF) method or into the space between the first substrate 110 and the second substrate 140 after assembling.

In FIG. 3C, the second substrate 140 is assembled with the first substrate 110. The second substrate 140 may be a thin film transistor (TFT) substrate or a color filter (CF) substrate comprising a glass substrate or indium tin oxide (ITO) substrate.

The liquid crystal display panel of the present invention comprises a hybrid spacer. During the one drop fill process, the soft material of the hybrid spacer decreases compressive resistance between the substrates, thus bubbles decrease. After the one drop fill process, the rigid material of the hybrid spacer increases compressive resistance between the substrates, thus durability of the liquid crystal display panel improves.

While the invention has been described by way of Example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A liquid crystal display panel, comprising:
a first substrate;
a second substrate disposed parallel to the first substrate;
a liquid crystal layer interposed between the first substrate and the second substrate; and
a plurality of spacers disposed between the first substrate and second substrate, wherein the spacers comprise a first material and a second material, wherein the pencil hardness of the first material is different from that of the second material.

2. The liquid crystal display panel as claimed in claim 1, wherein the first substrate is a thin film transistor (TFT) substrate.

3. The liquid crystal display panel as claimed in claim 2, wherein the second substrate is a color filter substrate.

4. The liquid crystal display panel as claimed in claim 1, wherein the first material and the second material are uniformly distributed in the at least one of the plurality of spacers.

5. The liquid crystal display panel as claimed in claim 1, wherein the first material comprises acrylic materials with pencil hardness of less than or equal to about 3H.

6. The liquid crystal display panel as claimed in claim 1, wherein the second material comprises acrylic materials with pencil hardness of more than or equal to about 3H.

7. The liquid crystal display panel as claimed in claim 1, wherein the first material and the second material are layered distributed.

8. The liquid crystal display panel as claimed in claim 1, wherein the thickness of the at least one of the plurality spacers is about 1 to 10 micrometer.

9. The liquid crystal display panel as claimed in claim 1, wherein the spacers are pillar-shaped.

10. The liquid crystal display panel as claimed in claim 1, wherein the spacers are ball-shaped.

11. A method for fabricating a liquid crystal display panel, comprising:
providing a first substrate;
forming a plurality of spacers on the first substrate, wherein the spacers comprise a first material and a second material, and the pencil hardness of the first material is different from that of the second material;
applying liquid crystal to the first substrate;
providing a second substrate; and
assembling the second substrate and the first substrate.

12. The method as claimed in claim 11, wherein the first substrate is a thin film transistor (TFT) substrate.

13. The method as claimed in claim 12, wherein the second substrate is a color filter substrate.

14. The method as claimed in claim 11, wherein the first material and the second material are uniformly distributed in the at least one of the plurality of spacers.

15. The method as claimed in claim 11, wherein the first material comprises acrylic materials with pencil hardness of less than or equal to about 3H.

16. The method as claimed in claim 11, wherein the second material comprises acrylic materials with pencil hardness of more than or equal to about 3H.

17. The method as claimed in claim 11, wherein the first material and the second material are layered distributed.

18. The method as claimed in claim 11, wherein the thickness of the spacer is about 1 to 10 micrometer.

19. The method as claimed in claim 11, wherein the spacers are pillar-shaped.

20. The method as claimed in claim 11, wherein the spacers are ball-shaped.

21. The method as claimed in claim 11, wherein the step of applying the liquid crystal to the first substrate is accomplished by an one drop fill (ODF) method.

22. The method as claimed in claim 11, wherein the step of forming the plurality of spacers on the first substrate comprises:
forming a resist layer on the first substrate; and
patterning the resist layer to form the spacers.

23. The method as claimed in claim 11, wherein the step of forming the plurality of spacers on the first substrate comprises:
forming a first resist layer on the first substrate;
forming a second resist layer on the first resist layer; and
patterning the first resist layer and the second resist layer to form the spacers.

24. The method as claimed in claim 23, wherein the first resist layer comprises the first material, and the second resist layer comprises the second material.

25. The method as claimed in claim 23, wherein the first resist layer comprises the second material and the second resist layer comprises the first material.

26. The method as claimed in claim 11, wherein the step of applying the liquid crystal to the first substrate follows the step of assembling the second substrate and the first substrate.
